(19) United States
(12) Patent Application Publication
(10) Pub. No.: US 2009/0194352 A1
(43) Pub. Date: Aug. 6, 2009

(54) Movable Side-By-Side Cooling Package

(76) Inventors: Sean Plante, Clearwater, KS (US); William Pearson, Bel Aire, KS (US); Joseph Biggerstaff, Wichita, KS (US); Eric Hensley, Wichita, KS (US); Benjamin Collogan, Bel Aire, KS (US); Brady Lewis, Peck, KS (US); Jason Bergkamp, Mount Hope, KS (US); Aaron Baldwin, Tahlequah, OK (US)

Correspondence Address: CNH AMERICA LLC;INTELLECTUAL PROPERTY LAW DEPARTMENT, P O BOX 1895, M.S. 641, NEW HOLLAND, PA, 17557, US

(21) Appl. No.: 12/023,918

(22) Filed: Jan. 31, 2008

(51) Int. Cl. B60K 6/00; F28F 7/00

(52) U.S. Cl. 180/294; 165/137

(57) ABSTRACT

A work vehicle includes a frame and a cooling package. The cooling package includes a water cooler and an oil cooler disposed in a fixed side-by-side arrangement. The water cooler and the oil cooler are movably supported side-by-side on the frame. The cooling package includes a front surface and a rear surface. The cooling package is configured to move on the frame to permit cleaning of the front surface of the cooling package.

### FIELD OF THE INVENTION

The present invention relates generally to work vehicles. It relates more particularly to a cooling package construction for a work vehicle.

### BACKGROUND OF THE INVENTION

Work vehicles, such as skid steer loaders, typically include a water cooler and an oil cooler supported on a frame of the work vehicle to cool the engine and fluid systems of the work vehicle. Typically, a fan is used to draw ambient air through coils of the water cooler and oil cooler to reduce the temperature of the water and oil, respectively, flowing through the cooler coils. During operation of the work vehicle, foreign matter, such as leaves, dust, etc., may accumulate on or proximate to the coils, adversely affecting the ability of the coolers to remove thermal energy from the engine and fluid systems of the work vehicle.

Accordingly, it would be advantageous to provide a compact cooling package construction that provides for the removal of foreign matter.

### SUMMARY OF THE INVENTION

One embodiment of the present invention relates to a work vehicle including a frame and a cooling package. The cooling package includes a water cooler and an oil cooler disposed in a fixed side-by-side arrangement. The water cooler and the oil cooler are movably supported side-by-side on the frame. The cooling package includes a front surface and a rear surface. The cooling package is configured to move on the frame to permit cleaning of the front surface of the cooling package.

Another embodiment of the present invention further relates to a cooler arrangement including a cooling package including a water cooler and an oil cooler disposed in a fixed side-by-side arrangement. The water cooler and the oil cooler are movably supported side-by-side on a frame. The cooling package includes a front surface and a rear surface. The cooling package is configured to move on the frame to permit cleaning of the front surface of the cooling package.

An advantage of the present invention is improved access to a cooling package of a work vehicle.

A further advantage of the present invention is a reduction in the number of parts included in the cooling package.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a top perspective rear view of an embodiment of a work vehicle showing a cooling package disposed in an operating position of the present invention.

FIG. 2 is a top perspective rear view of an embodiment of a work vehicle showing a cooling package disposed in a maintenance position of the present invention.

FIG. 3 is a top perspective front view of a cutaway of an embodiment of a work vehicle of the present invention.

FIG. 4 is an enlarged partial top perspective view of an embodiment of a work vehicle of FIG. 3 of the present invention.

FIG. 5 is an enlarged partial top perspective view of a portion of an embodiment of a cooling package of a work vehicle taken from region 5 of FIG. 4 of the present invention.

FIG. 6 is a top perspective rear view of an embodiment of a work vehicle showing a cooling package disposed in a maintenance position of the present invention.

FIG. 7 is an enlarged partial top perspective view of a cooling package taken from region 7 of FIG. 6 of the present invention.

Wherever possible, the same reference numbers will be used throughout the drawings to refer to the same or like parts.

### DETAILED DESCRIPTION OF THE INVENTION

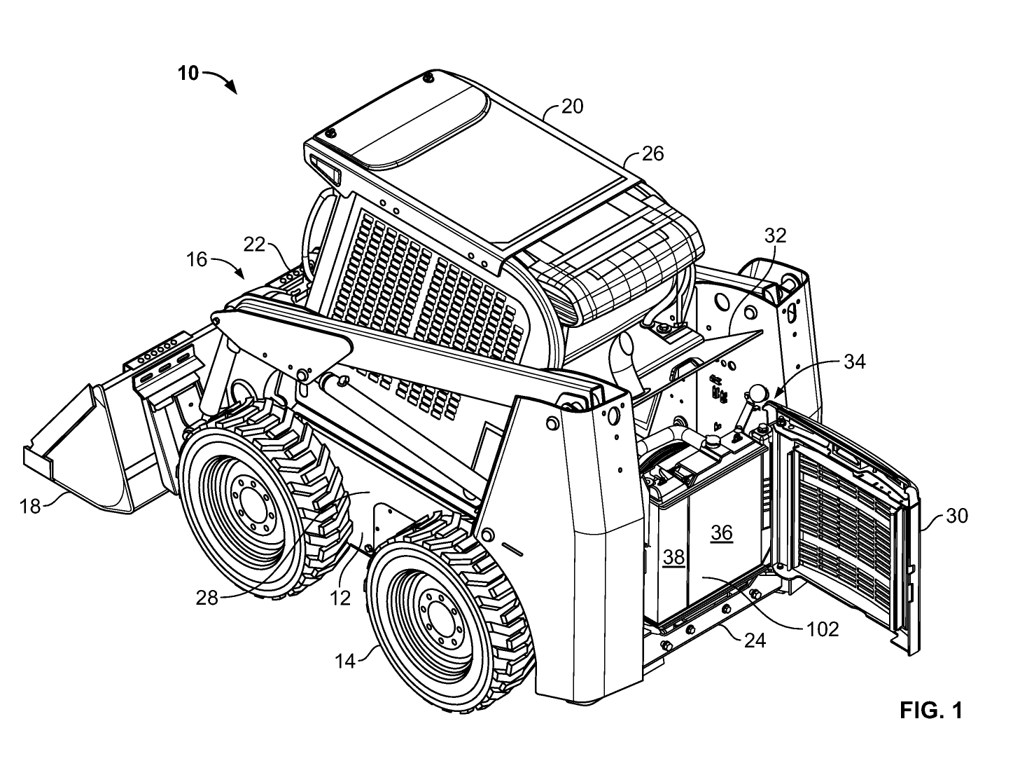

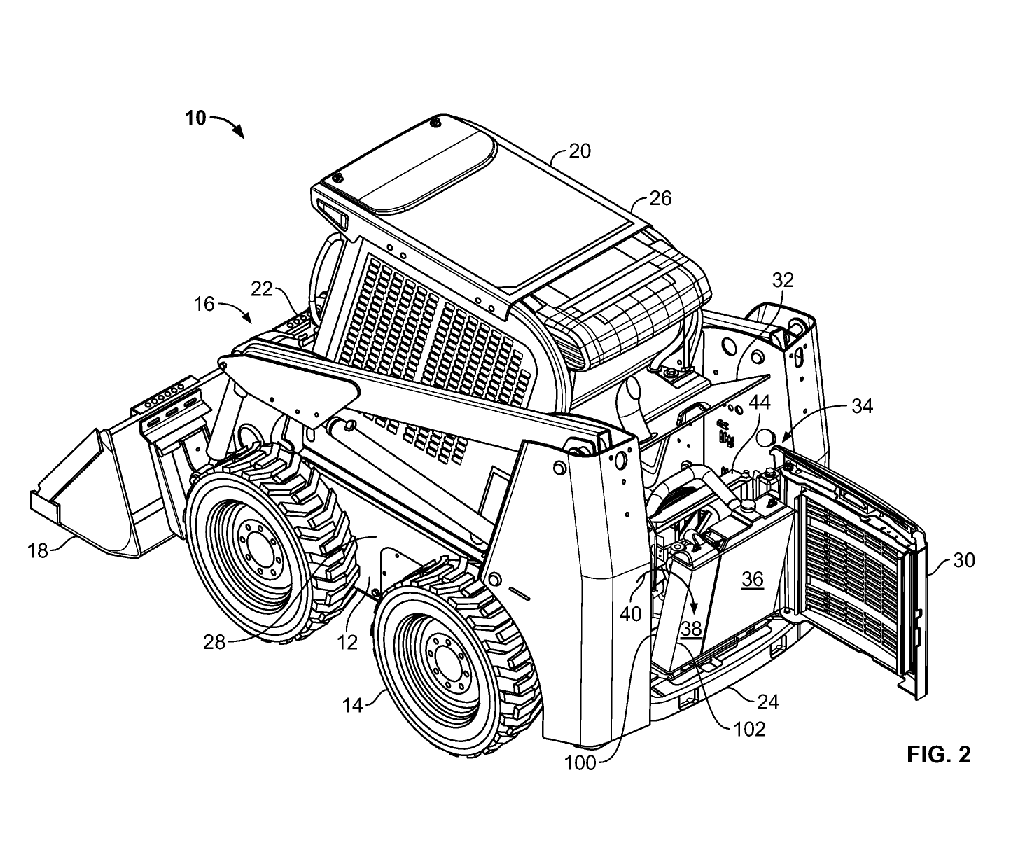

FIGS. 1-2 show an exemplary work vehicle 10 including a frame 12 that rotatably carries a plurality of wheels 14. An implement 18 including a structure 16 having an arrangement of structural members and actuators controllable by an operator (not shown) to manipulate implement 18 to perform work is also connected to frame 12. Implement 18 includes, but is not limited to, brooms, augers, rakes, bale spikes, buckets, blades, hammers, forks, hoes, rock wheels, stump grinders and tillers. In an alternate embodiment, structure 16 may maintain implement 18 in a fixed or non-moving relationship with frame 12. Frame 12 structurally supports a cab structure 20 to surround and protect the operator. The cab structure 20 may be configured to pivot with respect to frame 12. Frame 12 includes a front end 22 disposed proximate to implement 18. Front end 22 is disposed between opposed sides 26, 28 disposed between front end 22 and a rear end 24. A seat (not shown) is disposed interior of cab structure 20.

A rear door 30 and upper rear door 32, both shown opened in FIGS. 1 and 2, provide access to a movable cooling package 34. Movable cooling package 34 includes comprising a water cooler 36 and an oil cooler 38 disposed in a side-by-side arrangement, as shown in FIGS. 1 and 2. FIG. 1 shows cooling package 34 disposed in a closed or operating position. FIG. 2 shows cooling package 34 disposed in an opened or maintenance position by virtue of pivoting movement 40. By pivoting the cooling package 34 into an open or maintenance position, opposed front and rear surfaces 100, 102 (FIG. 2) of the cooling package 34 are easily accessed by a user (not shown) to remove foreign matter, including dust, leaves, brush, etc.

For purposes herein, the term side-by-side pertains to the exemplary embodiment of the rectangular cooling package including a front surface 100 and a rear surface 102 of each of the water cooler 36 and oil cooler 38 directly facing rear end 24 of work vehicle 10. The rear surface 102 of each of the water cooler 36 and oil cooler 38 directly faces fan housing 44. Stated another way, water cooler 36 and oil cooler 38 are not stacked in-line with one another with respect to the general direction of air drawn by fan 42 through rear door 30 and then through the water cooler 36 and oil cooler 38. It is to be understood that the term side-by-side does not require the front and rear surfaces 100, 102 of the water cooler 36 and oil cooler 38 to be aligned, as the term side-by-side may also include arrangements in which the water cooler 36 and oil cooler 38 are disposed at an angle to each other, and further includes non-rectangular constructions of the water cooler 36 and oil cooler 38.

In the exemplary embodiment, water cooler 36 and oil cooler 38 have a tube and fin construction, collectively referred to herein as coil structure, although other constructions may also be used, such as a bar/plate.

In addition to enhancing the ability to clean the cooling package 34, arranging a cooling package 34 in a side-by-side arrangement of the water cooler 36 and oil cooler 38 provides additional benefits. For example, the cooling efficiency of one or both of water cooler 36 and oil cooler 38 is increased in comparison to an otherwise similarly shaped water cooler 36 or oil cooler 38 having a stacked cooler construction, as typically found in known cooling package constructions. That is, in a stacked cooler construction, the water cooler typically overlies oil coolers. In this stacked arrangement, the temperature of the air increases as it flows through the coils of the water cooler. The heated air subsequently flows through the oil cooler to provide cooling. The amount of thermal exchange between the heated air and the coils of the oil cooler is reduced, by using heated air instead of air at ambient temperatures. Additionally, in the exemplary embodiment, the novel side-by-side arrangement negligibly increases the core area of the water cooler and oil cooler from 0.29 square meters to 0.33 square meters, thereby increasing cooling. In alternate embodiments, the core area of the cooler package of the present invention may be equal or less than stacked/in-line cooling packages.

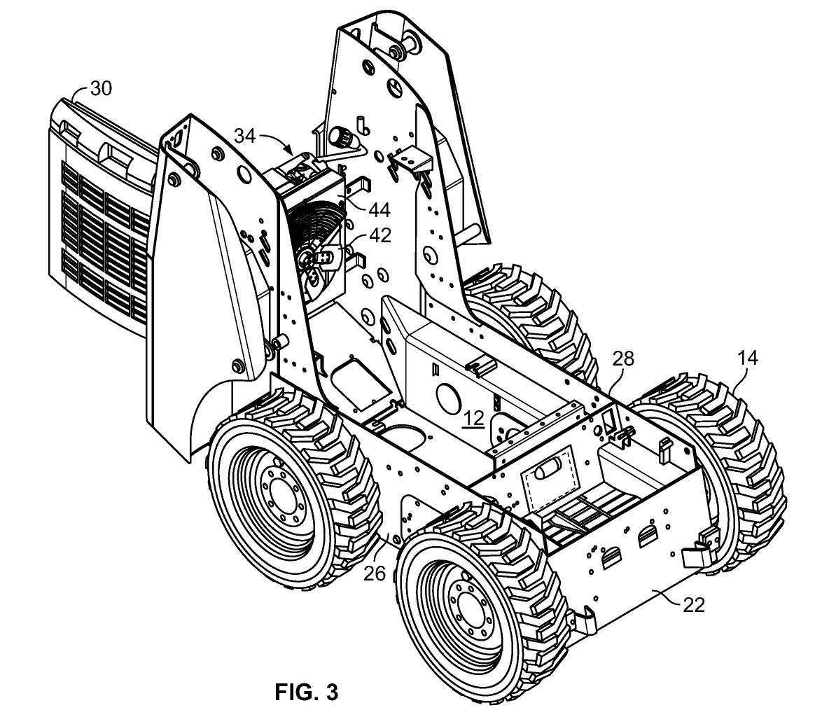

FIG. 3 is a top perspective front view of a cutaway of work vehicle 10. As shown In FIG. 3, a fan 42 is enclosed in a fan housing 44.

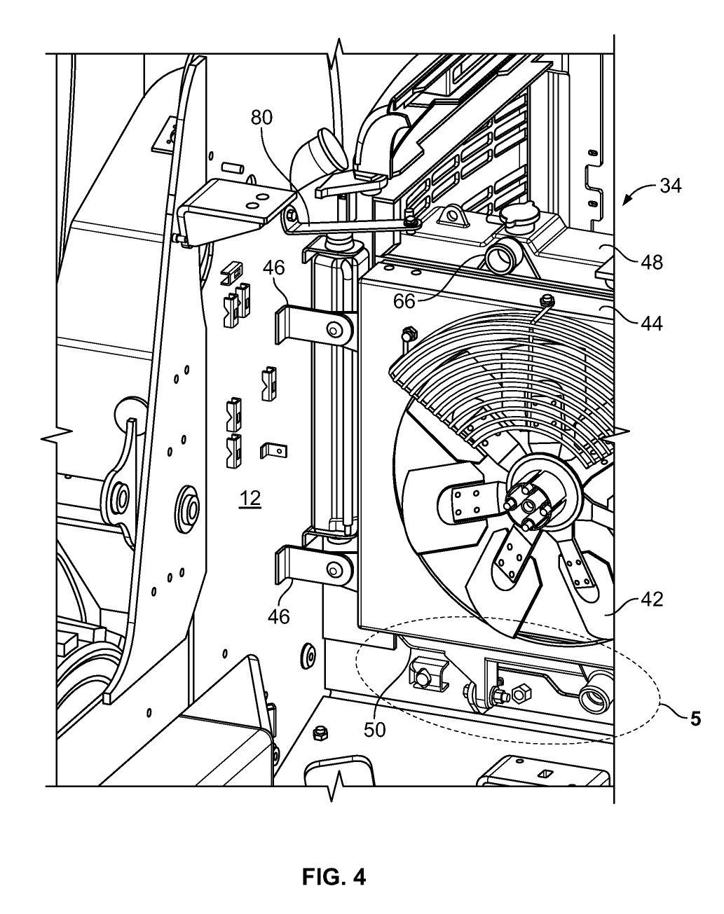

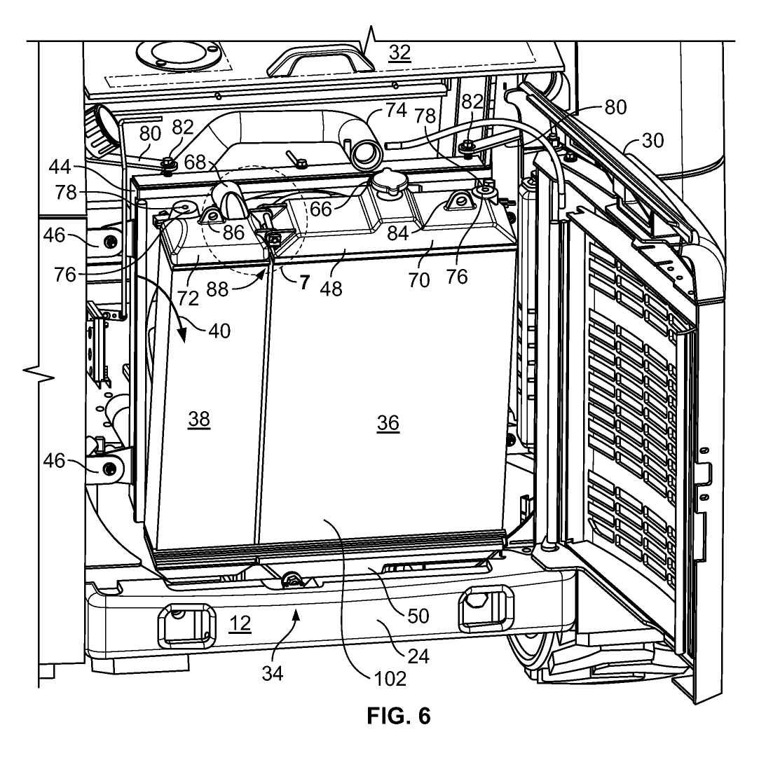

FIG. 4, which is an enlarged partial top perspective view of the exemplary embodiment of FIG. 3, shows a pair of brackets 46 connected to frame 12 that secure one side of fan housing 44 to frame 12. A second pair of brackets 46 (present on the opposite side of fan housing 44, but not shown in FIG. 4) secures an opposite side of fan housing 44 to frame 12. In the operating position as shown in FIG. 1, cooling package 34 is disposed in closed proximity to fan housing 44. A link 80 connected at one end to frame 12 is also connected at the other end to an upper frame 48 of cooling package 34 to maintain cooling package 34 in the operating position. A second link 80, see FIG. 6, may also be used to maintain cooling package 34 in the operating position (shown in FIG. 1). Cooling package 34 includes a lower frame 50 that is pivotably movable with respect to fan housing 44 and frame 12 to permit cleaning of the opposed surfaces of the cooling package 34.

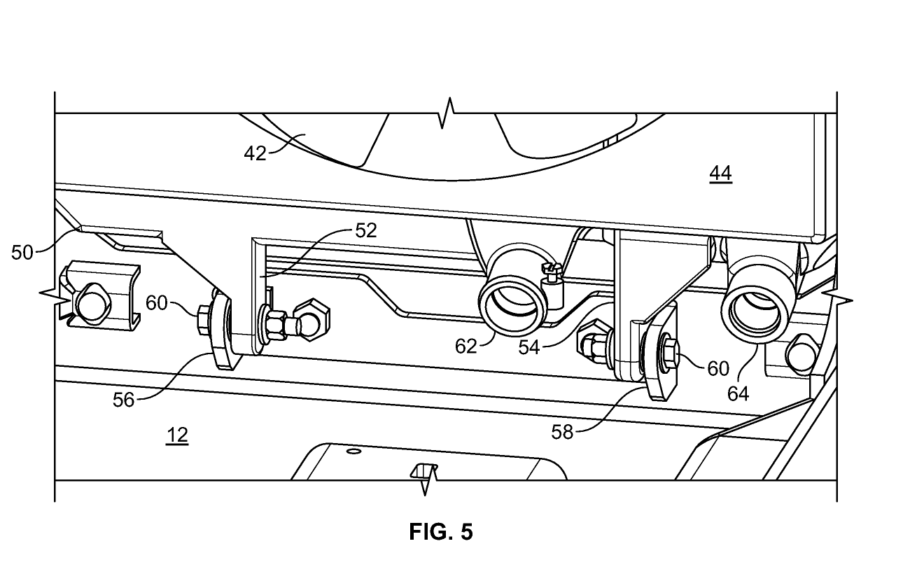

FIG. 5 is an enlarged partial top perspective rear view of a portion of cooling package 34 taken from region 5 of FIG. 4. As shown in FIG. 5, cooling package 34 is disposed aft of fan 42 and fan housing 44. FIG. 5 also shows a lower frame 50 disposed both aft of and in a lower position than fan housing 44. Lower frame 50 includes an outlet 62 for water cooler 36 (FIG. 1) and an outlet 64 for oil cooler 38 (FIG. 1). Lower frame 50 also includes a pair of downward extending fittings 52, 54. A fitting 56 extends outwardly from frame 12. Each of fittings 56 and 52 are configured to receive a fastener 60 and provide a pivotable connection between lower frame 50 and frame 12. Similarly, a fitting 58 extends outwardly from frame 12. Each of fittings 58 and 54 are configured to receive a fastener 60 and provide a pivotable connection between lower frame 50 and frame 12. In alternate embodiments, lower frame 50 may have one or more than two pivotable connections with frame 12. While the pivotable connections of the exemplary embodiment are axially aligned along a horizontal axis, pivotable connections of alternate embodiments are not limited to axially aligned configurations. Additionally, pivotable connections may be disposed at an axis or axes that are non-horizontal.

In the exemplary embodiment, the difference in angular orientation between the closed or operating position (FIG. 1) and the open or maintenance position (FIG. 2) of cooling package 34, from the pivoting movement 40 about the pivotal connections between frame 12 and lower frame 50 is about 12 degrees. In the exemplary embodiment, pivoting cooling package 34 about 12 degrees from the closed or operating position to the opened or maintenance position provides sufficient clearance between the surfaces of frame 12, fan 42, and fan housing 44, and the front surfaces 100 of water cooler 36 and oil cooler 38 to permit cleaning of the front surfaces 100 and corresponding surfaces of frame 12, fan 42 and fan housing 44. In other embodiments, a pivoting movement in excess of 12 degrees may be used. In addition, the arrangement of the cooling package 34 in the open or maintenance position shown in FIG. 2 permits cleaning of the water cooler 36 and oil cooler 38 side surfaces facing respective sides 26, 28. Preferably, none of the fluid connections of the work vehicle and the respective coolers 36, 38 must be disconnected.

In alternate embodiments, instead of the pivotable connections between lower frame 50 and frame 12 as provided for in this exemplary embodiment, other arrangements, such as rails, mechanical linkages, channels, etc. may be used to provide both a pivotable and translational movement of cooling package 34.

FIG. 6 shows a top perspective rear view of an embodiment of a work vehicle showing cooling package 34 disposed in the maintenance position. Upper frame 48 includes an upper frame portion 70 associated with water cooler 36 and an upper frame portion 72 associated with oil cooler 38. In the exemplary embodiment, upper frame portion 70 and a corresponding portion of lower frame 50 are pressed onto the coil structure of water cooler 36. Similarly, upper frame portion 72 and a corresponding portion of lower frame 50 are pressed onto the coil structure of oil cooler 38. The assembled cooling package 34 is of unitary construction. However, other techniques of joining respective portions of upper frame 48, lower frame 50 and coolers 36, 38, such as adhesives, application of heat, with or without other compounds or components, mechanical fasteners, or a combination thereof may also be used.

Each of upper frame portion 70 and upper frame portion 72 includes a boss 76 having an opening 78, such as a threaded opening, to receive a fastener 82 extending through a corresponding link 80 secured to frame 12. A lug 84 is formed in upper frame portion 70 of upper portion upper frame 48 and a lug 84 is formed in upper frame portion 72 of upper portion upper frame 48 to simplify handling of cooling package 34. Upper frame portion 70 includes an inlet 66 to receive hose 74 connected to engine (not shown). Water from the engine flows through hose 74 and then through inlet 66, flowing though water cooler 36 before exiting via outlet 62 (FIG. 5) prior to returning to the engine via another hose (not shown). In a similar fashion, oil received from a source (not shown) via an inlet 68 of upper frame portion 72 flows through the oil cooler 38 and exits via outlet 64 (FIG. 5) prior to returning to an accumulator (not shown). In the exemplary embodiment, upper frame 48 and lower frame 50 are constructed of cast metal, such as aluminum or other suitable metal, such as steel, although other suitable materials, such as thermoplastics, and non-cast materials may be used.

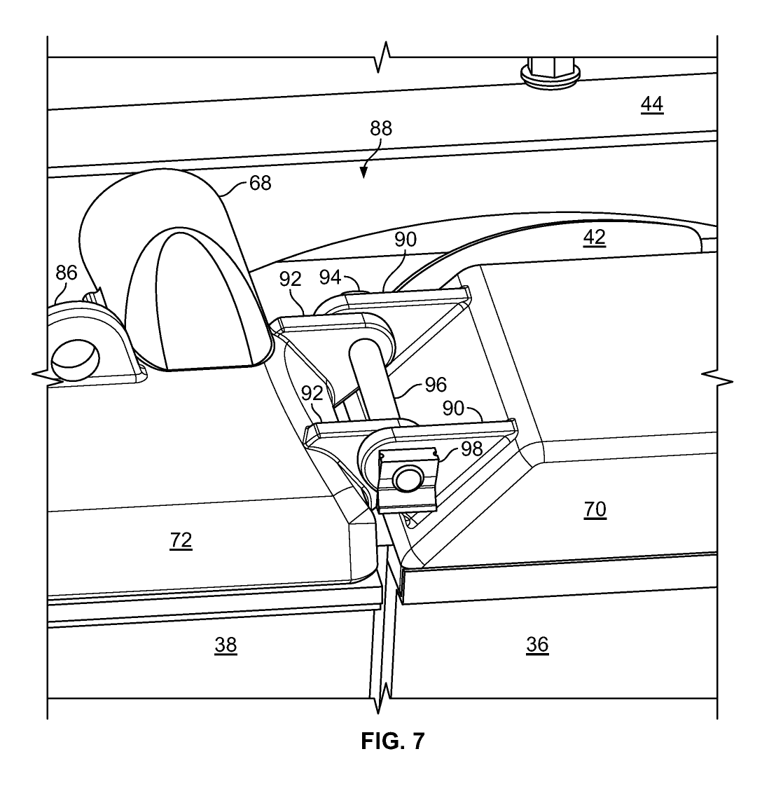

FIG. 7 is an enlarged partial top perspective view of an interconnecting region 88 is of cooling package 34 taken from region 7 of FIG. 6. Interconnecting region 88 is defined as the upper junction of water cooler 36 and oil cooler 38. As shown in FIG. 7, upper frame portion 72 includes a pair of parallel fittings 92 and upper frame portion 70 includes a pair of parallel fittings 90. When water cooler 36 and oil cooler 38 are fixed relative to each other to form cooling package 34, respective fittings 90, 92 mesh and are configured to receive a fastening arrangement, such as a fastener 94 and nut 98, including a spacer 96 disposed between meshed fittings 90, 92 to allow the water cooler 36 and oil cooler 38 to be disconnected. The fastening arrangement secures upper frame portion 70 to upper frame portion 72. In an alternate embodiment, lower frame 50 includes a similar construction as interconnecting region 88, in which lower frame 50 would include separable lower frame portions dedicated to a corresponding water cooler 36 and oil cooler 38. That is, water cooler 36 and oil cooler 38 would be disconnected from each other, permitting removal of only one of the coolers 36, 38 if desired, such as for damage repair, or to clean between the facing surfaces of the coolers 36, 38.

It is to be understood that fluids other than water may be used with water cooler 36.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A work vehicle comprising:
a frame; and
a cooling package comprising:
a water cooler and an oil cooler disposed in a fixed side-by-side arrangement; and
the water cooler and the oil cooler movably supported side-by-side on the frame; and
the cooling package comprising a front surface and a rear surface;
wherein the cooling package is configured to move on the frame to permit cleaning of the front surface of the cooling package.

2. The work vehicle of claim 1, wherein the cooling package is pivotable on the frame.

3. The work vehicle of claim 2, wherein the cooling package can pivot on the frame at least 12 degrees.

4. The work vehicle of claim 2, wherein the cooling package is pivotable on the frame about a horizontal or a non-horizontal axis.

5. The work vehicle of claim 2, wherein the cooling package is movable in translation on the frame.

6. The work vehicle of claim 1, wherein the cooling package is of unitary construction.

7. The work vehicle of claim 1, wherein at least one of an upper frame and a lower frame of the cooling package is a cast material.

8. The work vehicle of claim 1, wherein the upper frame includes a lifting lug.

9. The work vehicle of claim 7, wherein the upper frame and the lower frame are pressed onto the cooling package.

10. The work vehicle of claim 9, wherein the cooling package is composed of a tube and fin construction.

11. The work vehicle of claim 10, wherein the cooling package is separable.

12. A cooler arrangement comprising:
a cooling package comprising:
a water cooler and an oil cooler disposed in a fixed side-by-side arrangement; and
the water cooler and the oil cooler movably supported side-by-side on a frame; and
the cooling package comprising a front surface and a rear surface;
wherein the cooling package is configured to move on the frame to permit cleaning of the front surface of the cooling package.

13. The cooler arrangement of claim 12, wherein the cooling package is configured for a pivotable connection with the frame.

14. The cooler arrangement of claim 12, wherein the cooling package is of unitary construction.

15. The cooler arrangement of claim 12, wherein at least one of an upper frame and a lower frame of the cooling package is a cast material.

16. The cooler arrangement of claim 12, wherein the cooling package includes a lifting lug.

17. The cooler arrangement of claim 15, wherein the upper frame and the lower frame are pressed onto the cooling package.

18. The cooler arrangement of claim 17, wherein the cooling package is composed of a tube and fin construction.

19. The cooler arrangement of claim 17, wherein the cooling package is separable.
